(19) United States
(12) Patent Application Publication
(10) Pub. No.: US 2015/0211703 A1
(43) Pub. Date: Jul. 30, 2015

(54) VEHICULAR LAMP

(71) Applicant: KOITO MANUFACTURING CO., LTD., Tokyo (JP)

(72) Inventors: Misako Nakazawa, Shizuoka (JP); Takayuki Yagi, Shizuoka (JP); Satoshi Yamamura, Shizuoka (JP)

(21) Appl. No.: 14/603,981

(22) Filed: Jan. 23, 2015

(30) Foreign Application Priority Data
Jan. 24, 2014 (JP) 2014-011588

(51) Int. Cl. F21S 8/10

(52) U.S. Cl. CPC F21S 48/125; F21S 48/1757

(57) ABSTRACT

A vehicular lamp has a two-dimensional image display device, and a projection lens that projects light from the two-dimensional image display device ahead of the lamp. The two-dimensional image display device has a display portion that is disposed on a rear focal point of the projection lens and that displays an image, and a transparent member disposed apart from the display portion by a predetermined distance on a side of the projection lens.

### BACKGROUND

1. Technical Field

The present invention relates to a vehicular lamp and particularly to a vehicular lamp that includes a two-dimensional image display device such as a micro-electro-mechanical systems (MEMS) mirror array.

2. Related Art

A conventionally known vehicular lamp is equipped with a light source, a MEMS mirror array that controls light distribution by reflecting light from the light source, and a projection lens that projects light from the MEMS mirror array forward. This vehicular lamp forms a desired light distribution pattern by performing ON/OFF control of each of multiple micro mirrors provided in the MEMS mirror array.

### RELATED ART DOCUMENT

### Patent Document

[Patent Document 1]

Japanese Patent Application Laid-Open (Kokai) No. 2012-190594

### SUMMARY

In a vehicular lamp including a two-dimensional image display device such as a MEMS mirror array, when attached substances such as dusts are attached to a display portion that displays an image, light diffused by the attached substances is projected ahead of the lamp by the projection lens. This may dazzle pedestrians and drivers of oncoming vehicles.

One or more embodiments of the present invention provides an art for reducing glare caused by attached substances such as dusts in a vehicular lamp including a two-dimensional image display device.

A vehicular lamp according to one or more embodiments of the present invention includes a two-dimensional image display device and a projection lens that projects light from the two-dimensional image display device ahead of the lamp. The two-dimensional image display device includes a display portion that is disposed on a rear focal point of the projection lens and that displays an image, and a transparent member disposed apart from the display portion by a predetermined distance on a side of the projection lens.

A space between the display portion and the transparent member may be sealed.

The two-dimensional image display device may be a mirror array in which multiple micro mirrors are arranged in an array so as to be capable of controlling their tilt angles independently.

The predetermined distance may be 1.5 mm or more, and 2.5 mm or less.

According to one or more embodiments of the present invention, glare caused by attached substances such as dusts can be reduced in a vehicular lamp including a two-dimensional image display device.

### BRIEF DESCRIPTION OF THE DRAWINGS

FIG. 1 is a vertical sectional view showing a schematic structure of a vehicular lamp according to one or more embodiments of the present invention.

FIG. 2 is an enlarged view of a transparent member and its surroundings.

FIG. 3 is a view showing a relationship of a distance between a display portion and a transparent member and glare by reflection.

### DETAILED DESCRIPTION

Hereinafter, embodiments of the present invention will be described in detail below with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. Like reference numerals are used for like or corresponding components, members, and processes shown in the drawings, and duplicate descriptions are omitted as appropriate. The embodiments do not intend to limit the invention, but are provided as examples. Not all of the features and the combinations thereof described in the embodiments are essential to the invention.

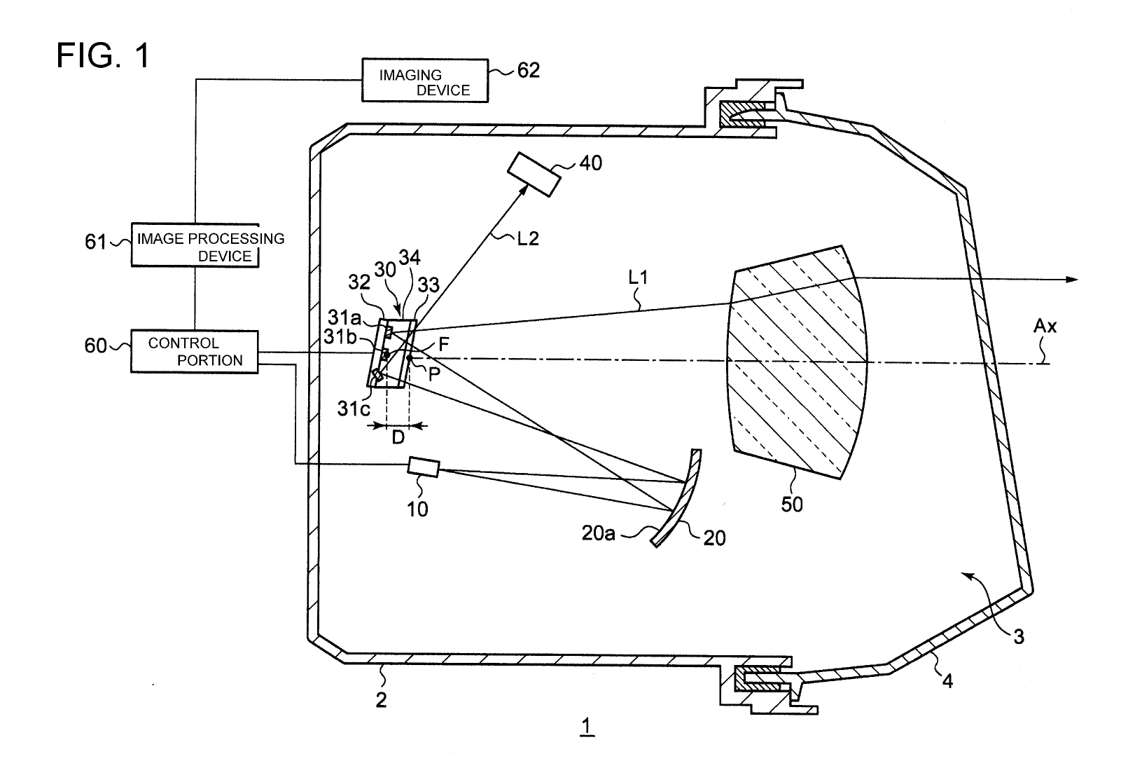

FIG. 1 is a vertical sectional view showing a schematic structure of a vehicular lamp according to one or more embodiments of the present invention. A vehicular lamp 1 according to one or more embodiments of the present invention is a vehicular headlamp apparatus including paired headlamp units disposed on both left and right of the front of a vehicle. The paired headlamp units have substantially the identical structure except that they have bilaterally-systematic structures. Therefore, FIG. 1 shows the structure of one of the headlamp units as the vehicular lamp 1.

The vehicular lamp 1 includes a lamp body 2 having an opening at a vehicle front side and a translucent cover 4 attached so as to cover the opening of the lamp body 2. The translucent cover 4 is formed of resin, glasses, or the like having translucency. In a lamp chamber 3 formed of the lamp body 2 and the translucent cover 4, a light source 10, a reflector 20, a two-dimensional image display device 30, a light absorbing member 40, and a projection lens 50 are accommodated. Each component is attached to the lamp body 2 via a supporting mechanism (not shown).

The light source 10 may be a light-emitting diode (LED), a semiconductor laser, a bulb, or the like. The light source 10 is disposed so as to radiate light toward the reflector 20. The reflector 20 has a reflective surface 20a formed into a curve. The reflector 20 reflects light from the light source 10 toward the two-dimensional image display device 30. The reflector 20 is not necessarily provided, but light from the light source 10 may be directly radiated toward the two-dimensional image display device 30.

The two-dimensional image display device 30 according to one or more embodiments of the present invention is a MEMS mirror array. The two-dimensional image display device 30 includes a display portion 32 on which multiple micro mirrors (FIG. 1 shows three micro mirrors 31a to 31c. In the following description, multiple micro mirrors are collectively referred to as “micro mirrors 31”) are arranged in an array, a transparent member 33 disposed apart from the display portion 32 by a predetermined distance D on a side of the projection lens 50, and a supporting portion 34 that supports the transparent member 33 ahead of the display portion 32.

Each of the micro mirrors 31 of the display portion 32 is capable of switching between two states independently by changing its tilt angle according to the control signal from a control portion 60: a state in which light from the reflector 20 is radiated toward a projection lens 50 positioned in the front of the lamp (hereinafter referred to as the “ON state”) and a state in which light from the light source 10 is radiated toward the light absorbing member 40 provided at a position separate from the projection lens 50 (hereinafter referred to as the “OFF state”). The display portion 32 is capable of displaying a two-dimensional image by changing the tilt angle of each of the micro mirrors 31. For example, in FIG. 1, the micro mirror 31a positioned on the upper side of the display portion 32 is in the ON state while the micro mirror 31c positioned on the lower side of the display portion 32 is in the OFF state. Light L1 reflected to the front of the lamp from the micro mirror 31a that is in the ON state is incident to the projection lens 50. On the other hand, light L2 reflected from the micro mirror 31c that is in the OFF state is incident to and absorbed by the light absorbing member 40.

The transparent member 33 is a plate-shaped member formed of a material transparent (for example, glasses, resin materials such as polycarbonate and acryls) to light emitted by the light source 10. The outer shape of the transparent member 33 is formed so as to cover the entire area of the display portion 32. The thickness of the transparent member 33 is not particularly limited.

The supporting portion 34 is disposed so as to surround a space between the display portion 32 and the transparent member 33. The supporting portion 34 is configured so as to seal the space between the display portion 32 and the transparent member 33.

The projection lens 50 is, for example, formed of a free-form curved surface lens whose front side surface and rear side surface have free-form curved shapes. The projection lens 50 projects an image formed on a rear focal plane including a rear focal point F of the projection lens 50 as an inverted image on a virtual vertical screen in front of the lamp. The projection lens 50 is disposed so that the rear focal point F is positioned on the center of a light emitting surface of the display portion 32 (that is, a reflective surface of the micro mirror 31b positioned on the center of the display portion 32). Therefore, the projection lens 50 projects an image displayed on the display portion 32 of the two-dimensional image display device 30 as an inverted image on the virtual vertical screen in front of the lamp.

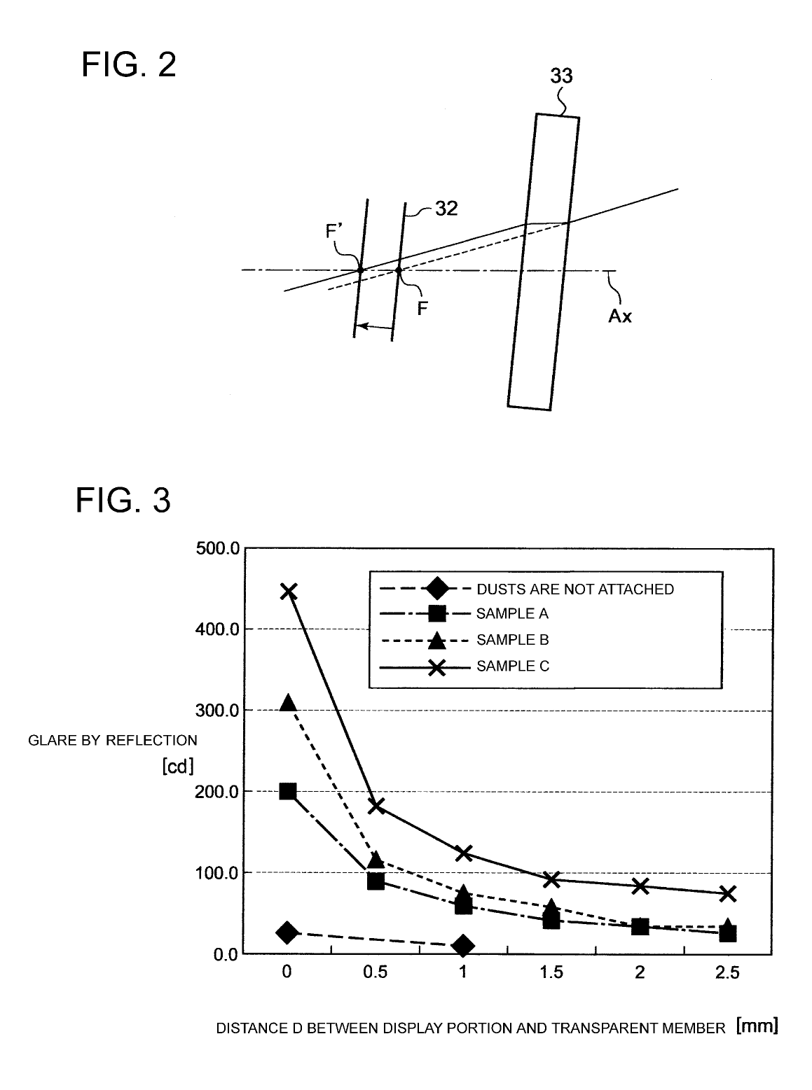

FIG. 2 is an enlarged view of the transparent member 33 and its surroundings. As shown in FIG. 2, in the case where thickness is applied to the transparent member 33, a rearward focal point F′ taking into consideration of effects of refraction of the transparent member 33 may be used as a rear focal point of the projection lens, instead of the rear focal point F of the single projection lens. That is, the projection lens 50 may be disposed so that the rearward focal point F′ taking into consideration of effects of retraction is positioned on the center of the light emitting surface of the display portion 32.

In one or more embodiments of the present invention, the control portion 60 adjusts the intensity of light emitted from the light source 10 and controls the tilt angle of each of the micro mirrors 31 of the two-dimensional image display device 30. The control portion 60 is realized by elements or circuits that are typified by CPU or memory of computers as a hardware structure, and is realized by computer programs and the like as a software structure. The control portion 60 is provided outside the lamp chamber 3 in FIG. 1, but may be provided in the lamp chamber 3. The control portion 60 receives signals from an image processing device 61 connected to an imaging device 62 and a light switch or the like (not shown). Then, the control portion 60 transmits various control signals to the light source 10 and the two-dimensional image display device 30 according to the received signals.

The imaging device 62 is disposed so as to take an image ahead of the lamp. The image processing device 61 obtains an image data taken with the imaging device 62 and performs image processing. Accordingly, the image processing device 61 identifies vehicles, pedestrians, lane marks, and the like contained in the image data, and detects these positions. Arts that identify vehicles, pedestrians, lane marks, and the like and that detect these positions are known, whereby detailed descriptions are omitted here. The detected positional information is transmitted to the control portion 60. The control portion 60 controls the tilt angles of the micro mirrors 31 with these positional information to form a desired image on the display portion 32.

As described above, in the vehicular lamp 1 according to one or more embodiments of the present invention, the transparent member 33 is disposed apart from the display portion 32 by a predetermined distance D on a side of the projection lens 50. In detail, the distance D indicates a distance from the intersection point between the micro mirrors 31 of the display portion 32 and an optical axis Ax of the projection lens 50 (equal to the rear focal point F in FIG. 1) to the intersection point between a surface of the transparent member 33 on a side of the projection lens 50 and an optical axis Ax of the projection lens 50. In such a configuration, even if attached substances such as dusts are attached to the surface of the transparent member 33 on the side of the projection lens 50, the focal point of the projection lens 50 does not coincide with the position of the attached substances because the transparent member 33 is provided apart from the display portion 32 by the predetermined distance D. Therefore, it is possible to avoid a situation where glare is caused by light that is diffused by the attached substances and that is projected ahead of the lamp by the projection lens 50. A space between the display portion 32 and the transparent member 33 is sealed, whereby attached substances such as dusts are not attached to the surface of the transparent member 33 on the side of the display portion 32 or its risk is extremely low.

FIG. 3 is a view showing a relationship of the distance D between the display portion 32 and the transparent member 33 and glare by reflection. Here, an experiment was performed to observe a change in glare by reflection when the distance D between the transparent member 33 (samples A, B, and C) to which dusts are attached and the display portion 32 was changed. The amount of dusts attached is different among the samples A, B, and C. As a reference, the result of a sample to which dusts are not attached is also shown. Note that the thickness of the transparent member 33 is extremely thin and can be ignored.

As shown in FIG. 3, the values of glare by reflection are different among the samples A, B, and C. However, the values of glare by reflection largely decrease as the distance D is increased from 0 mm to 1.5 mm. When the distance D is 1.5 mm or more, the values of glare by reflection do not almost change. Based on this result, according to one or more embodiments of the present invention, glare caused by attached substances can be reduced by setting the distance D between the display portion 32 and the transparent member 33 as 1.5 mm or more. When the distance D between the display portion 32 and the transparent member 33 is made too large, sealing performance is reduced or the size of the two-dimensional image display device 30 is increased. Accordingly, according to one or more embodiments of the present invention, the distance D between the display portion 32 and the transparent member 33 is set as 2.5 mm or less.

Embodiments of the present invention are set forth above as merely examples; a person skilled in the art will recognize that various modifications may be made to the combinations of components and processing processes, and that such modifications are also within the scope of the present invention.

One or more of the above embodiments illustrate examples of a MEMS mirror array provided with multiple micro mirrors as a two-dimensional image display device. However, the two-dimensional image display device is not limited to the MEMS mirror array, and may be a diffraction type MEMS array having multiple movable ribbons or a liquid crystal panel.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### DESCRIPTION OF THE REFERENCE NUMERALS

1: VEHICULAR LAMP,
3: LAMP CHAMBER,
4: TRANSLUCENT COVER,
10: LIGHT SOURCE,
20: REFLECTOR,
30: TWO-DIMENSIONAL IMAGE DISPLAY DEVICE,
31: MICRO MIRROR,
32: DISPLAY PORTION,
33: TRANSPARENT MEMBER,
34: SUPPORTING PORTION,
40: LIGHT ABSORBING MEMBER,
50: PROJECTION LENS,
60: CONTROL PORTION,
61: IMAGE PROCESSING DEVICE
62: IMAGING DEVICE

1. A vehicular lamp comprising:
a two-dimensional image display device, and a projection lens that projects light from the two-dimensional image display device ahead of the lamp,
wherein the two-dimensional image display device comprises:
a display portion that is disposed on a rear focal point of the projection lens and that displays an image, and
a transparent member disposed apart from the display portion by a predetermined distance on a side of the projection lens.

2. The vehicular lamp according to claim 1, wherein a space between the display portion and the transparent member is sealed.

3. The vehicular lamp according to claim 1, wherein the two-dimensional image display device is a mirror array in which multiple micro mirrors are arranged in an array so as to be capable of controlling their tilt angles independently.

4. The vehicular lamp according to claim 1, wherein the predetermined distance is 1.5 mm or more.

5. The vehicular lamp according to claim 4, wherein the predetermined distance is 2.5 mm or less.

6. The vehicular lamp according to claim 2, wherein the two-dimensional image display device is a mirror array in which multiple micro mirrors are arranged in an array so as to be capable of controlling their tilt angles independently.

7. The vehicular lamp according to claim 2, wherein the predetermined distance is 1.5 mm or more.

8. The vehicular lamp according to claim 3, wherein the predetermined distance is 1.5 mm or more.
